(19) United States
(12) Patent Application Publication
(10) Pub. No.: US 2021/0172886 A1
(43) Pub. Date: Jun. 10, 2021

(54) IMAGE DISTORTION CORRECTION FOR X-RAY DETECTOR

(71) Applicant: Illinois Tool Works, Inc., Glenview, IL (US)

(72) Inventors: Michael Glatzmaier, St. Louis Park, MN (US); Joseph Schlecht, Edina, MN (US); Eric Ferley, Rogers, MN (US)

(21) Appl. No.: 16/950,765

(22) Filed: Nov. 17, 2020

Related U.S. Application Data
(60) Provisional application No. 62/944,178, filed on Dec. 5, 2019.

(51) Int. Cl. G01N 23/046; G01N 23/083

(52) U.S. Cl. CPC G01N 23/046; G01N 23/083; G01N 2223/3306; G01N 2223/401; G01N 2223/5015; G01N 2223/04

(57) ABSTRACT

Techniques are disclosed for identifying and reducing pixel-specific image distortion of an x-ray detector. In one example, an x-ray detector obtains, for various calibration positions, two-dimensional (2D) images of a calibration object. The calibration object comprises reference points that comprise spatial characteristics. Processing circuitry computes an image distortion field across a plurality of pixels of the x-ray detector based on imaged characteristics of the reference points in each of the 2D images, the spatial characteristics of the reference points, and the calibration positions. The processing circuitry computes, based on the computed image distortion field, a correction transform for correcting image distortion across the x-ray detector. The processing circuitry applies the correction field to a preliminary image obtained by the x-ray detector to obtain a corrected image exhibiting reduced pixel-specific image distortion.

This application claims the benefit of U.S. Provisional Application No. 62/944,178, which was filed on Dec. 5, 2019, the entire content of which is incorporated herein by reference.

### TECHNICAL FIELD

This disclosure generally relates to x-ray inspection of objects.

### BACKGROUND

X-ray computed tomography (CT) is a procedure that uses computer-processed x-rays to produce tomographic images of an object. A tomographic image of an object is an image of a conceptually two-dimensional “slice” of the object. A computing device may use the tomographic images of the object to generate a 3-dimensional image of the object. X-ray CT may be used for industrial purposes to conduct non-destructive evaluation of objects. X-ray metrology is a related technique in which x-rays are used to measure internal and external dimensions of objects under test. An x-ray inspection apparatus includes an x-ray source that radiates x-rays toward an object under test. The x-ray inspection apparatus further includes an x-ray detector that receives the radiated x-rays to obtains an image of the object under test. An x-ray inspection apparatus may be used to obtain radiographic images of parts or other objects in production environments, or other types of environments.

### SUMMARY

In accordance with the techniques of the disclosure, methods, systems, and devices are disclosed for identifying and reducing pixel-specific image distortion of an x-ray detector of an x-ray inspection apparatus. The x-ray detector is, e.g., a flat-panel x-ray detector that comprises a plurality of pixels. In one example, the x-ray detector obtains a plurality of two-dimensional (2D) images of a calibration object. The calibration object comprises one or more reference points. For example, the calibration object may include a plurality of x-ray-attenuating (e.g., x-ray-opaque or partially x-ray-opaque) spheres arranged in a grid pattern. The x-ray detector obtains each 2D image from a different calibration position of a plurality of calibration positions. Each of the calibration positions corresponds to a different spatial arrangement of the x-ray detector relative to the calibration object. Different calibration positions may be achieved by moving the x-ray detector relative to the calibration object or moving the calibration object relative to the x-ray detector.

Processing circuitry of the x-ray inspection apparatus uses imaged characteristics of the one or more reference points of the calibration object in each 2D image of the plurality of 2D images, spatial characteristics of the one or more reference points, and the plurality of calibration positions to compute an image distortion field across the plurality of pixels of the x-ray detector. The image distortion field describes a pixel-specific distortion error of each pixel of the plurality of pixels of the x-ray detector.

The spatial characteristics of the one or more reference points may be, e.g., a size of each of the one or more reference points or a position of each reference point of the one or more reference points in relation to one another. The imaged characteristics of the one or more reference points in each 2D image of the plurality of 2D images may be, e.g., an imaged size or an imaged position of each reference point of the one or more reference points in each 2D image of the plurality of 2D images. For example, the processing circuitry computes an estimated position or an estimated size of each of the one or more reference points in each 2D image of the plurality of 2D images based on the size or the position of each reference point of the one or more reference points in space and the plurality of calibration positions. The processing circuitry determines a difference between the estimated position or the estimated size of each of the one or more reference points in each 2D image of the plurality of 2D images and the imaged size or the imaged position of each reference point of the one or more reference points in each 2D image of the plurality of 2D images. Further, the processing circuitry computes the image distortion field across the plurality of pixels of the x-ray detector based on the determined difference.

In further examples, the processing circuitry computes, based on the computed image distortion field across the plurality of pixels of the x-ray detector, a correction transform for correcting image distortion across the plurality of pixels of the x-ray detector. For example, the processing circuitry approximates a function that minimizes a difference between the estimated position or the estimated size of each of the one or more reference points in each 2D image of the plurality of 2D images and the imaged size or the imaged position of each reference point of the one or more reference points in each 2D image of the plurality of 2D images. The x-ray detector subsequently obtains a preliminary 2D image of an object under test. The processing circuitry may apply the correction transform to the preliminary 2D image to generate a corrected 2D image of the object under test. The corrected 2D image may exhibit reduced pixel-specific image distortion as compared to the preliminary image. Therefore, the techniques of the disclosure may enable processing circuitry of an x-ray inspection apparatus to generate and use a correction transform to reduce image distortion across a plurality of pixels of an x-ray detector so as to obtain high-fidelity images.

The techniques of the disclosure provide specific improvements to the computer-related field of x-ray CT that have practical applications. For example, an x-ray inspection apparatus as described herein may detect and reduce the occurrence of pixel-specific image distortion that occurs due to mechanical and manufacturing variations in the individual pixels of the x-ray detector. Furthermore, the techniques of the disclosure may allow for the identification and reduction of pixel-specific, three-dimensional (3D) error in the x-ray detector without the need to generate a 3D reconstruction of the spatial orientation and relationship between the object under test and the x-ray detector. Therefore, the techniques of the disclosure may reduce the complexity of calibrating an x-ray inspection apparatus while increasing the accuracy of images produced by such an x-ray inspection apparatus.

In one example, this disclosure describes a method comprising: obtaining, with an x-ray detector comprising a plurality of pixels, a plurality of 2D images of a calibration object, wherein each 2D image of the plurality of 2D images is obtained from a respective calibration position of a plurality of calibration positions, wherein each of the calibration positions is different spatial arrangement of the x-ray detector relative to the calibration object, and wherein the calibration object comprises one or more reference points; computing, with processing circuitry, an image distortion field across the plurality of pixels of the x-ray detector based on respective imaged characteristics of the one or more reference points in each 2D image of the plurality of 2D images, respective spatial characteristics of the one or more reference points, and the plurality of calibration positions; and computing, with the processing circuitry and based on the computed image distortion field across the plurality of pixels of the x-ray detector, a correction transform for correcting image distortion across the plurality of pixels of the x-ray detector, wherein the respective spatial characteristics of the one or more reference points comprise at least one of a size or a position of each reference point of the one or more reference points in space, and wherein the respective imaged characteristics of the one or more reference points in each 2D image of the plurality of 2D images comprise at least one of an imaged size or an imaged position of each reference point of the one or more reference points in each 2D image of the plurality of 2D images.

In another example, this disclosure describes an x-ray inspection apparatus comprising: an x-ray detector comprising a plurality of pixels, the x-ray detector configured to obtain a plurality of 2D images of a calibration object, wherein the x-ray detector is configured to obtain each 2D image of the plurality of 2D images from a respective calibration position of a plurality of calibration positions, wherein each of the calibration positions is a different spatial arrangement of the x-ray detector relative to the calibration object, and wherein the calibration object comprises one or more reference points; and processing circuitry configured to: compute an image distortion field across the plurality of pixels of the x-ray detector based on respective imaged characteristics of the one or more reference points in each 2D image of the plurality of 2D images, respective spatial characteristics of the one or more reference points, and the plurality of calibration positions; and compute, based on the computed image distortion field across the plurality of pixels of the x-ray detector, a correction transform for correcting image distortion across the plurality of pixels of the x-ray detector, wherein the respective spatial characteristics of the one or more reference points comprise at least one of a size or a position of each reference point of the one or more reference points in space, and wherein the respective imaged characteristics of the one or more reference points in each 2D image of the plurality.

In another example, this disclosure describes a non-transitory, computer-readable medium comprising instructions that, when executed, are configured to cause processing circuitry to: receive a plurality of 2D images of a calibration object, each 2D image of the plurality of 2D images obtained from a respective calibration position of a plurality of calibration positions, wherein each of the calibration positions is a different spatial arrangement of an x-ray detector comprising a plurality of pixels relative to the calibration object, wherein the calibration object comprises one or more reference points; compute an image distortion field across the plurality of pixels of the x-ray detector based on respective imaged characteristics of the one or more reference points in each 2D image of the plurality of 2D images, respective spatial characteristics of the one or more reference points, and the plurality of calibration positions; and compute, based on the computed image distortion field across the plurality of pixels of the x-ray detector, a correction transform for correcting image distortion across the plurality of pixels of the x-ray detector, wherein the respective spatial characteristics of the one or more reference points comprise at least one of a size or a position of each reference point of the one or more reference points in space, and wherein the respective imaged characteristics of the one or more reference points in each 2D image of the plurality.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an example x-ray inspection apparatus that may perform one or more techniques of this disclosure.

FIG. 2 is a block diagram illustrating the example x-ray inspection apparatus of FIG. 1 in further detail.

FIGS. 3A-3B are illustrations depicting an example of the calibration object of FIG. 1 from various perspectives.

FIG. 4 is a block diagram illustrating the example x-ray inspection apparatus of FIG. 1 in further detail.

FIG. 5A is an illustration of imaged positions of one or more reference points as depicted in a plurality of 2D images obtained by an x-ray detector at a plurality of calibration positions in accordance with the techniques of this disclosure.

FIG. 5B is an illustration of estimated positions of one or more reference points within the plurality of 2D images obtained by an ideal x-ray detector at each of the plurality of calibration positions in FIG. 5A in accordance with the techniques of this disclosure.

FIG. 5C is an illustration of a difference between the imaged positions of the one or more reference points of FIG. 5A and the estimated positions of the one or more reference points of FIG. 5B in accordance with the techniques of this disclosure.

FIG. 5D is an illustration of an image distortion field of the x-ray detector of FIG. 1 computed in accordance with the techniques of this disclosure.

FIG. 6 is a flowchart illustrating an example operation in accordance with the techniques of the disclosure.

FIG. 7 is an illustration depicting examples of an x-ray detector, calibration object, and rotary table of the x-ray inspection apparatus of FIG. 1.

FIG. 8 is a photograph depicting another example of the calibration object of FIG. 1 in further detail.

FIGS. 9A-9B are renderings of another example of the calibration object of FIG. 1 in further detail.

FIG. 10A is an example illustration of a radiograph of an example calibration object of FIG. 1.

FIG. 10B is a chart illustrating pixel-specific image distortion present in the radiograph of FIG. 10A.

FIG. 10C is a chart illustrating a reduction in the pixel-specific image distortion in the radiograph of FIG. 10A using the techniques of the disclosure.

Like reference characters refer to like elements throughout the figures and description.

### DETAILED DESCRIPTION

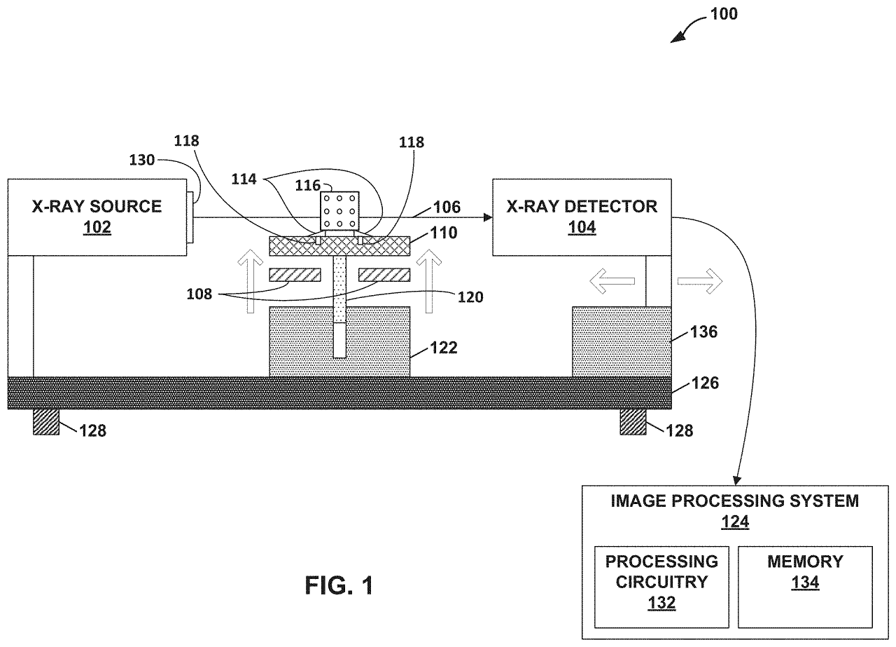

FIG. 1 is a block diagram illustrating an example x-ray inspection apparatus 100 that may perform one or more techniques of this disclosure. An x-ray inspection apparatus may also be referred to as an x-ray imaging apparatus. In the example of FIG. 1, apparatus 100 includes an x-ray source 102 and an x-ray detector 104. In some examples, apparatus 100 is an “inline” x-ray inspection apparatus in which apparatus 100 is used to inspect a flow of products in a production environment. That is, apparatus 100 may implement an inline system for continuous x-ray inspection of parts in a production environment. Such x-ray inspection can be computed tomography (CT), digital radiography (DR), automatic defect recognition (ADR), or other types of inspection. In other examples, apparatus 100 may be used on a “per part” basis.

When in operation, x-ray source 102 emits an x-ray beam 106. Hence, in some instances, this disclosure may refer to x-ray source 102 or similar devices as “x-ray generators.” In some examples, x-ray beam 106 is cone shaped. In other examples, x-ray beam 106 is fan shaped. Furthermore, in some examples, x-ray source 102 generates x-rays with an energy range of 20 keV to 600 keV. In other examples, x-ray source 102 generates x-rays in other energy ranges.

Apparatus 100 may include various types of x-ray detectors. For example, x-ray detector 104 may include a flat panel x-ray detector (FPD) that comprises a plurality of pixels. In other examples, x-ray detector 104 may include a lens-coupled scintillation detector, a linear diode array (LDA), or another type of x-ray detector. A FPD may include a layer of scintillation material, such as Cesium Iodide fabricated on amorphous silicon on a glass detector array. The scintillator layer absorbs x-rays and emits visible light photons that are, in turn, detected by a solid-state detector. The detector pixel size may range from tens to hundreds of micrometers. In some examples where x-ray detector 104 comprises a flat-panel x-ray detector, the pixel size of x-ray detector 104 may be in the range of 25 micrometers to 250 micrometers. In some examples, the pixel size of x-ray detector 104 may be in the range of approximately 25 micrometers to approximately 250 micrometers. Furthermore, the field of view of common commercial FPDs may range from approximately 100 mm to 500 mm. Commercial FPDs may be used in applications requiring large fields of view.

High-resolution applications may use lens-coupled detectors that use an optical lens to relay emitted visible light to a detector, such as a charge-coupled device (CCD) or a complementary metal-oxide-semiconductor (CMOS) detector. In some examples, the lens may provide magnification in the range of 1× to 100×, thus making the effective pixel size between 0.1 to 20 micrometers. In some examples where x-ray detector 104 comprises a lens-coupled detector, the pixel size of x-ray detector 104 is in a range of 0.1 micrometers to 10 micrometers. Furthermore, in some examples where x-ray detector 104 comprises a lens-coupled detector, the field of view may range from 0.2 mm to 25 mm.

In some examples, in addition to x-ray source 102 and x-ray detector 104, apparatus 100 may comprise a feed assembly. Because of the perspective of FIG. 1, the feed assembly is not wholly visible. The feed assembly conveys part carriers, such as part carrier 110, into and out of an inspection area of apparatus 100. The feed assembly may be implemented in various ways. For example, the feed assembly may be implemented using a ring drive, a serpentine track, a perforated conveyor belt, a chain drive, or another type of assembly for moving one or more part carriers into and out of the inspection area of apparatus 100.

In the example of FIG. 1, the feed assembly conveys part carriers in a direction into and out of the page. Hence, the feed assembly is omitted from FIG. 1. However, FIG. 1 depicts two carrier support members 108 of the feed assembly, one on either side of part carrier 110. However, in other examples, carrier support members 108 are differently aligned or disposed.

A part carrier is an object designed for supporting objects (e.g., parts) to be inspected by apparatus 100. In some examples, part carriers may be disc shaped. However, in other examples, part carriers may have different shapes, such as squares, rectangles, ovals, or other shapes. Furthermore, throughout the figures of this disclosure, part carriers are shown as having flat top surfaces. However, in other examples, part carriers may have differently formed top surfaces. For instance, part carriers may be convex, concave, beveled, or have raised outer edges.

In some examples, part support members are mounted on part carriers. In some examples, part support members are formed on part carriers. Part support members are designed to support particular types of objects to be inspected by apparatus 100. Part support members may be designed to hold an object at a constant position relative to a part carrier. Part support members may be specifically formed to support particular types of objects. Part support members may be formed from a material substantially transparent to x-rays, such that part support members do not give rise, in radiographs, to artifacts that disrupt the inspection process being performed.

In the example of FIG. 1, part support members 114 support a calibration object 116. Furthermore, in the example of FIG. 1, part support members 114 are triangular shaped objects. However, part support members may have a wide variety of shapes specifically created for holding particular types of objects. For instance, part support members may be ring-shaped, may comprise a set of prongs, and so on. In the example of FIG. 1, calibration object 116 is spherical. However, in other examples, x-ray imaging apparatus 100 may perform x-ray imaging of other objects of a wide variety of types, sizes, and shapes, such as, e.g., artificial heart valves and other medical devices, electronic components, and so on. In some examples, calibration object 116 may be supported by a fixed-position platform.

Because part support members 114 may be specifically created for holding particular types of objects, part carriers may be formed in such a way that variously shaped part support members may be mounted on the part carriers. For example, a part carrier may be formed to define a set of holes. In this example, part support members may have engagement members formed to fit into one or more of the holes. For instance, in the example of FIG. 1, part support members 114 have peg-shaped engagement members 118 that engage holes defined in an upper surface of part carrier 110.

In some examples, part carriers and part support members comprise magnets and/or have magnetic properties. As such, part support members may be mounted on and held in place on part carriers using magnetic fixturing. In other words, magnetic fields hold part support members in place on part carriers. In this way, a part carrier may include magnets arranged to mount a part support member to the part carrier, the part support member configured to support an object for inspection. Thus, it may be unnecessary for part support members 114 to have engagement members 118 as shown in the example of FIG. 1 or for part carriers to define holes for accepting engagement members of part support members. In some such examples, part carriers may comprise 400 series stainless steel tops to allow for magnetic fixturing.

In some examples, part support members are detachable from part carriers. Thus, with different part support members mounted on part carriers, the part carriers may be reused for different types of objects to be inspected. Thus, part carriers do not need to be specialized for particular types of objects. Thus, special tooling required for inspection of different parts may be minimized or eliminated. In some examples, apparatus 100, as a whole, may provide a “neutral” means to pass parts through the system without internal equipment tooling changes.

In the example of FIG. 1, when the feed assembly conveys a part carrier to the inspection area of apparatus 100, the feed assembly positions part carrier 110 directly above a lift member 120 of a drive assembly 122. In the example of FIG. 1, drive assembly 122 raises lift member 120 such that lift member 120 engages a lower surface of part carrier 110 and lifts part carrier 110 off carrier support members 108 of the feed assembly, as indicated by the vertical arrows. In this way, drive assembly 122 may vertically position object 116 into an elevated inspection area between x-ray source 102 and x-ray detector 104. In some examples, drive assembly 122 or another apparatus may translate objects laterally, vertically, rotationally, or in other directions.

Thus, apparatus 100 may comprise x-ray source 102, x-ray detector 104, and drive assembly 122. Drive assembly 122 may be configured to lift a part carrier such that the part carrier is disengaged from a feed assembly and an object mounted on the part carrier is positioned between x-ray source 102 and x-ray detector 104. The part carrier is configured to feed part carriers into and out of the x-ray inspection apparatus 100. Drive assembly 122 is further configured to subsequently lower the part carrier such that the part carrier is reengaged with the feed assembly.

When object 116 is in the elevated inspection area, as shown in FIG. 1, x-ray detector 104 may detect x-rays generated by x-ray source 102 that pass through object 116. Image processing system 124 processes signals (e.g., electrical signals, optical signals, etc.) corresponding to the detected x-rays to generate radiographs of object 116. Image processing system 124 includes processing circuitry 132 and memory 134. In some examples, image processing system 123 includes one or more computing devices. In some examples, calibration object 116 and/or objects to be inspected may be manually placed on a platform such that x-ray detector 105 may detect x-rays generated by x-ray source 102 that pass through object 116.

In some examples, processing circuitry 132 of image processing system 124 is one or more microprocessors, digital signal processors (DSPs), application specific integrated circuits (ASICs), field programmable gate arrays (FPGAs), or any other equivalent integrated or discrete logic circuitry, as well as any combinations of such components. In some examples, memory 134 of image processing system 124 is random access memory (RAM), read only memory (ROM), programmable read only memory (PROM), erasable programmable read only memory (EPROM), electronically erasable programmable read only memory (EEPROM), flash memory, comprising executable instructions for causing the one or more processors to perform the actions attributed to them. Further, this memory may be implemented entirely in hardware, software, or a combination thereof.

Furthermore, in some examples, when an object, such as calibration object 116 or another object, is in the elevated inspection area, drive assembly 122 may rotate lift member 120, and in doing so, drive assembly 122 may lift part carrier 110 and the object. Hence, drive assembly 122 may be configured to rotate part carrier 110 while part carrier 110 is disengaged from the feed assembly. This may enable image processing system 124 to generate radiographs of the object from multiple rotation angles. In some examples, image processing system 124 processes the radiographs according to a process known as computed tomography (CT) to generate a 3D image of object 116. Furthermore, in some examples, image processing system 124 employs CT-based metrology inspection (e.g., dimensional inspection).

In some examples, drive assembly 122 raises and rotates lift member 120 such that apparatus 100 is able to generate radiographs of object 116 has various angles and elevations in accordance with a technique called “helical computed tomography.” In such examples, a ray from x-ray source 102 may trace a helical pattern on object 116 as drive assembly 122 raises and rotates object 116. Helical computed tomography may be useful for inspecting elongated objects.

After apparatus 100 has captured sufficient radiographs of object 116, drive assembly 122 may lower lift member 120 such that part carrier 110 again rests on carrier support members 108 of the feed assembly and lift member 120 disengages from part carrier 110. After lift member 120 disengages from part carrier 110, the feed assembly may remove part carrier 110 from the inspection area of apparatus 100 and bring another part carrier into the inspection area of apparatus 100.

In the example of FIG. 1, x-ray source 102, x-ray detector 104, and drive assembly 122 are mounted to a base 126. In some examples, base 126 is a solid, heavy material, such as granite. Moreover, in the example of FIG. 1, base 126 rests on vibration isolators 128. Vibration isolators 128 may include or be made of various vibration dampening materials, such as rubbers, gels, and so on. Vibration isolators 128, plus the weight of base 126, may serve to isolate x-ray source 102, x-ray detector 104, and drive assembly 122 from external vibration. In some examples, no part of the feed assembly is in direct contact with base 126 or any component mounted to base 126. Thus, x-ray source 102 and x-ray detector 104 may be vibrationally isolated from the feed assembly. Furthermore, when lift member 120 lifts part carrier 110 off carrier support members 108 of the feed assembly, part carrier 110 and hence object 116 are vibrationally isolated from the feed assembly. Thus, x-ray source 102, x-ray detector 104, and drive assembly 122 (e.g., CT rotation stage) are all mechanically attached together in a single assembly which is vibration isolated from the rest of the system and the outside world. Such vibrational isolation may prevent artifacts in radiographs resulting from vibrations.

In some examples, x-ray source 102 may remain powered and may continue generating x-rays even when apparatus is not generating radiographs of objects. For instance, x-ray source 102 may continue generating x-rays while the feed assembly is conveying part carriers into and out of an inspection area of apparatus 100. Keeping x-ray source 102 powered on in this fashion may help ensure x-rays generated by x-ray source 102 have a consistent energy level and may reduce costs of operating and/or maintaining apparatus 100. However, leaving x-ray source 102 powered up may present a safety hazard to operators and adjacent personnel if x-ray source 102 remains powered up as parts are moved into and out of the inspection area.

In some examples, a radiological shield (not shown in FIG. 1) of apparatus 100 may be shaped to substantially prevent emission (e.g., emission at levels potentially harmful to humans or exceeding applicable safety regulations) of x-rays into an environment outside x-ray inspection apparatus 100.

Furthermore, in the example of FIG. 1, x-ray source 102 is equipped with a tube shutter 130. Tube shutter 130 may block x-rays generated by x-ray source 102 from exiting x-ray source 102. In examples where x-ray source 102 continues to generate x-rays, tube shutter 130 may close while the feed apparatus to conveying part carriers into and out of the inspection area of apparatus 100. Tube shutter 130 may reopen when a part carrier is in position in the inspection area of apparatus 100. Having tube shutter 130 blocking x-rays from exiting x-ray source 102 may prevent unnecessary damage to x-ray detector 104 from continuous exposure to x-rays.

Furthermore, in some examples, a beam collimator may also be affixed near x-ray source 102 to reduce x-ray scatter, radiation shielding requirements and improve image quality. The beam collimator may narrow a beam of x-rays emitted by x-ray source 102.

In some examples, apparatus 100 may include or may be accompanied by equipment configured to load and unload part carriers from the feed assembly. In some examples, the equipment may position part carriers (or objects mounted thereon) at different locations, based on the outcome of the analysis by image processing system 124. In other examples, humans may load and unload part carriers. Thus, apparatus 100 may be operated as a stand-alone device, directly operated by a human, or integrated into a production line in a fully automated application.

Although not illustrated in the example of FIG. 1, apparatus 100 may comprise devices, such as heat exchangers, air conditioning units, air filters, or other devices, to control the air temperature within apparatus 100. Thus, apparatus 100 may perform inspections conditions that are vibration isolated, temperature controlled, and with x-ray source 102 powered up in a steady state. Furthermore, curved shielding paths for parts entering and exiting the test chamber (e.g., inspection area of apparatus 100) may also allow the test chamber to be maintained at a constant, stable temperature and humidity during inspection. Devices may be added for controlling air purity, air quality, temperature, humidity, or any other air characteristics.

An inspection process may include generating particular radiographs and analyzing the generated radiographs to determine whether an object conforms to a standard. For instance, an inspection process may comprise generating a particular number of radiographs with particular positioning characteristics, exposure characteristics (e.g., radiation intensity levels, exposure times, etc.), and other characteristics. The positioning characteristics for a radiograph may comprise a vertical height to which the part carrier is lifted for the radiograph and an angle of rotation for the radiograph. The positioning characteristics may also involve horizontal and/or vertical positions of x-ray source 102 and/or x-ray detector 104. Determining whether the object conforms to the standard may include applying various criteria to determine whether the object sufficiently conforms to the standard. For instance, the inspection process may specify particular size tolerances and other criteria. Apparatus 100 may use such criteria in determining whether the object passes inspection. In this way, in some examples, one or more processors of apparatus 100 may determine, based on information read from an identification tag of a part carrier, at least one of: how many radiographs to generate to inspect the object, positioning characteristics of the radiographs, exposure characteristics of the radiographs, and a standard.

Additional description of an x-ray inspection apparatus may be found in U.S. application Ser. No. 15/740,369 to Kirschenman, entitled “INLINE X-RAY MEASUREMENT APPARATUS AND METHOD,” filed on Jun. 10, 2016, the entire content of which is incorporated herein by reference.

In accordance with the techniques of the disclosure, methods, systems, and devices are disclosed for identifying and reducing pixel-specific image distortion of x-ray detector 104 of x-ray inspection apparatus 100. In one example, x-ray detector 104 obtains a plurality of 2D images of calibration object 116. X-ray detector 104 obtains each 2D image from a different calibration position. Each of the calibration positions is a different spatial arrangement of x-ray detector 104 relative to calibration object 116. In some examples, x-ray detector 104 is affixed to drive apparatus 136. In the example of FIG. 1, drive apparatus 136 is configured to move x-ray detector 104 so each x-ray detector 104 and calibration object 116 may have each of the plurality of different calibration positions. In some examples, each calibration position is precisely located at a predetermined or measured distance from calibration object 116. In some examples, drive apparatus 136 is configured to move x-ray detector 104 in a translational direction with respect to calibration object 116 (e.g., a horizontal movement to the left, right, toward, or away from calibration object 116, or a vertical movement above or below calibration object 116). In some examples, drive apparatus 136 is configured to move x-ray detector 104 in a rotational direction with respect to calibration object 116 (e.g., clockwise or counter-clockwise around calibration object 116). In some examples, a drive apparatus (e.g., drive assembly 122) may be configured to move calibration object 116 so that x-ray detector 104 and calibration object 116 may have each of the calibration positions.

Calibration object 116 comprises one or more reference points. In some examples, calibration object 116 comprises one or more reference points. In some examples, each of the one or more reference points of calibration object 116 is an x-ray-attenuating (e.g., x-ray-opaque or partially x-ray-opaque) sphere. In some examples, the one or more reference points of calibration object 116 are arranged in a grid pattern. For example, calibration object 116 may comprise a grid pattern with each x-ray-attenuating sphere of a plurality of x-ray-attenuating spheres located at a vertex of the grid. Typically, the size and/or position of each reference point is precisely determined such that calibration object 116 may be used to calibrate x-ray inspection apparatus as described herein.

Processing circuitry 132 of image processing system 124 uses imaged characteristics of the one or more reference points of calibration object 116 in each 2D image of the plurality of 2D images, spatial characteristics of the one or more reference points of calibration object 116, and the plurality of calibration positions to compute an image distortion field across the plurality of pixels of x-ray detector 104. The image distortion field describes a pixel-specific distortion error of each pixel of the plurality of pixels of the x-ray detector 104.

As described herein, the spatial characteristics of the one or more reference points refers to the actual, calibrated, or measured position or size of the one or more reference points in space (e.g., the real world). In contrast to the spatial characteristics, the imaged characteristics of the one or more reference points refers to the size or position of the one or more reference points as imaged by x-ray detector 104 and represented in the plurality of 2D images.

Due to variations in manufacturing of the plurality of pixels of x-ray detector 104, the plurality of pixels of x-ray detector 104 may exhibit inconsistencies or variations across x-ray detector 104 that result in distortion of the 2D image. For example, these image distortions may cause the imaged characteristics of the one or more reference points in each 2D image of the plurality of 2D images to vary from the spatial characteristics of the one or more reference points. As an illustration, the image distortion may cause the imaged size or imaged position of, e.g., each x-ray opaque sphere of calibration object 116 to vary slightly from a size or position of the plurality of reference in the real world. Furthermore, such image distortion may be not be constant or uniform across the plurality of pixels of x-ray detector 104. For example, the image distortion may be dependent on a position of x-ray detector 104 with respect to calibration object 116, or nonlinear across the plurality of pixels of x-ray detector 104. In some examples, the image distortion across x-ray detector 104 may be described by a 3D image distortion field, such as a 3D rotational image distortion error between calibration object 116 and x-ray detector 104 or a 3D translational image distortion error between calibration object 116 and x-ray detector 104.

The spatial characteristics of the one or more reference points may be, e.g., a size of each of the one or more reference points or a position of each reference point of the one or more reference points in relation to one another in space. For example, where the one or more reference points comprises a plurality of x-ray attenuating spheres arranged in a grid pattern, the spatial characteristics may be, e.g., a size of each x-ray attenuating sphere or a position of each x-ray attenuating sphere in relation to each other x-ray attenuating sphere of the plurality of x-ray attenuating spheres. Typically, the size and/or position of each reference point is precisely determined such that calibration object 116 may be used to calibrate x-ray inspection apparatus as described herein.

The imaged characteristics of the one or more reference points in each 2D image of the plurality of 2D images may be, e.g., an imaged size or an imaged position of each reference point of the one or more reference points in each 2D image of the plurality of 2D images. For example, where the one or more reference points comprise a plurality of x-ray attenuating spheres arranged in a grid pattern, the imaged characteristics may be, e.g., the size of each x-ray attenuating sphere or the position of each x-ray attenuating sphere in relation to each other x-ray attenuating sphere of the plurality of x-ray attenuating spheres, as depicted in the 2D image.

As described herein, processing circuitry 132 of image processing system 124 computes an estimated position or an estimated size of each of the one or more reference points in each 2D image of the plurality of 2D images based on the size or the position of each reference point of the one or more reference points in space and the plurality of calibration positions. Processing circuitry 132 determines a difference between the estimated position or the estimated size of each of the one or more reference points in each 2D image of the plurality of 2D images and the imaged size or the imaged position of each reference point of the one or more reference points in each 2D image of the plurality of 2D images. Processing circuitry 132 computes, based on the determined difference, an image distortion field across the plurality of pixels of x-ray detector 104 that describes the pixel-specific image distortion across x-ray detector 104.

Processing circuitry 132 may further compute, based on the computed image distortion field across the plurality of pixels of x-ray detector 104, a correction transform. Processing circuitry 132 may use the correction transform for subsequent correction of image distortion across the plurality of pixels of x-ray detector 104. For example, processing circuitry 132 approximates a function that minimizes a difference between the estimated position or the estimated size of each of the one or more reference points in each 2D image of the plurality of 2D images and the imaged size or the imaged position of each reference point of the one or more reference points in each 2D image of the plurality of 2D images.

Subsequently, x-ray detector 104 may obtain a preliminary 2D image of an object under test (e.g., calibration object 116 or another object not depicted in FIG. 1, such as an object undergoing production testing). Processing circuitry 132 applies the correction transform to the preliminary 2D image to generate a corrected 2D image of the object under test. The corrected 2D image may exhibit reduced pixel-specific image distortion as compared to the preliminary image. Therefore, the techniques of the disclosure enable processing circuitry 132 of x-ray inspection apparatus 100 to generate and use a correction transform to reduce image distortion across a plurality of pixels of x-ray detector 104 so as to obtain high-fidelity images.

The aforementioned techniques may be generally applicable to a flat panel x-ray detector. However, the techniques of the disclosure may also be implemented in an LDA x-ray detector. In such an example, the one or more reference points of calibration object 116 may comprise one or more spheres, cylinders, or pins. Where the reference points comprise cylinders or pins, in some examples each of the cylinders or pins comprise a constant diameter. Furthermore, instead of obtaining a plurality of 2D images of the calibration object, an LDA x-ray detector may obtain a plurality of one-dimension (1D) images of the calibration object and use such plurality of 1D images to compute a 1D correction transform in a similar fashion to the methodology described above.

The techniques of the disclosure provide specific improvements to the computer-related field of x-ray CT that have practical applications. For example, an x-ray inspection apparatus as described herein may detect and reduce the occurrence of pixel-specific image distortion that occurs due to mechanical and manufacturing variations in the individual pixels of the x-ray detector. Furthermore, the techniques of the disclosure may allow for the identification and reduction of pixel-specific, 3D error in the x-ray detector without the need to generate a 3D reconstruction of the spatial orientation and relationship between the object under test and the x-ray detector. Therefore, the techniques of the disclosure may reduce the complexity of calibrating an x-ray inspection apparatus while increasing the accuracy of images produced by such an x-ray inspection apparatus.

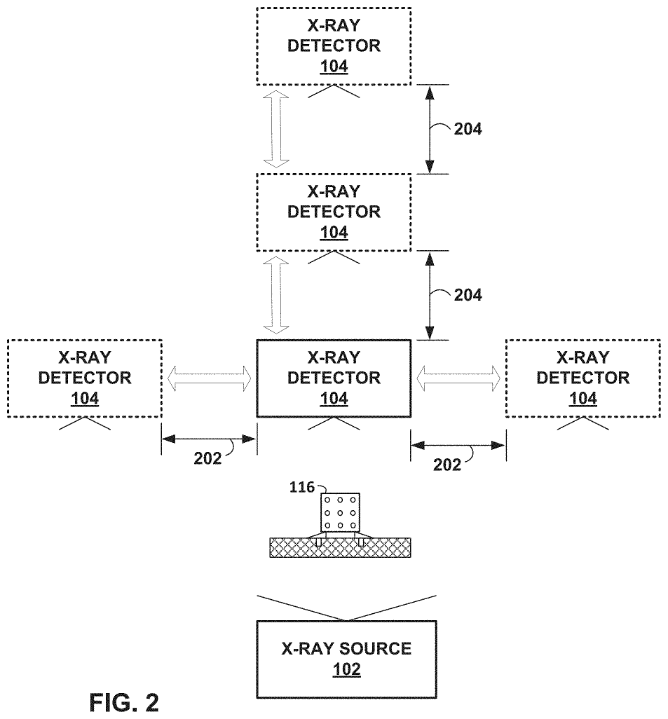

FIG. 2 is a block diagram illustrating the example x-ray inspection apparatus of FIG. 1 in further detail. As depicted in FIG. 2, x-ray detector 104 obtains each 2D image of a plurality of 2D images from different positions of a plurality of calibration positions. Each of the calibration positions corresponds to a different spatial arrangement of the x-ray detector relative to the calibration object. In some examples, each position of the plurality of calibration positions comprises a different vertical arrangement of the x-ray detector relative to the calibration object. In some examples, each position of the plurality of calibration positions comprises a different horizontal arrangement of the x-ray detector relative to the calibration object. In some examples, each position of the plurality of calibration positions comprises a different rotational arrangement of the x-ray detector relative to the calibration object.

For example, as described above with respect to FIG. 1, x-ray detector 104 may be affixed to drive apparatus 136, which may be configured to move x-ray detector 104 to various positions to achieve different spatial arrangements of x-ray detector 104 relative to calibration object 116. For example, drive apparatus 136 may move x-ray detector 104 along various horizontal positions with respect to calibration object 116. Each horizontal position may be spaced apart by a measured distance 202 from each other horizontal position. As another example, drive apparatus 136 may move x-ray detector 104 along various vertical positions with respect to calibration object 116. Each vertical position may be spaced apart by a measured distance 204 from each other vertical position. In other examples not depicted in FIG. 2, drive apparatus 136 may move x-ray detector 104 toward or away from calibration object 116, or rotationally around calibration object 116. In some examples, a drive apparatus (e.g., drive assembly 122) may be configured to move calibration object 116 instead of x-ray detector 104 or in addition to x-ray detector 104 so that x-ray detector 104 and calibration object 116 may have each of the calibration positions.

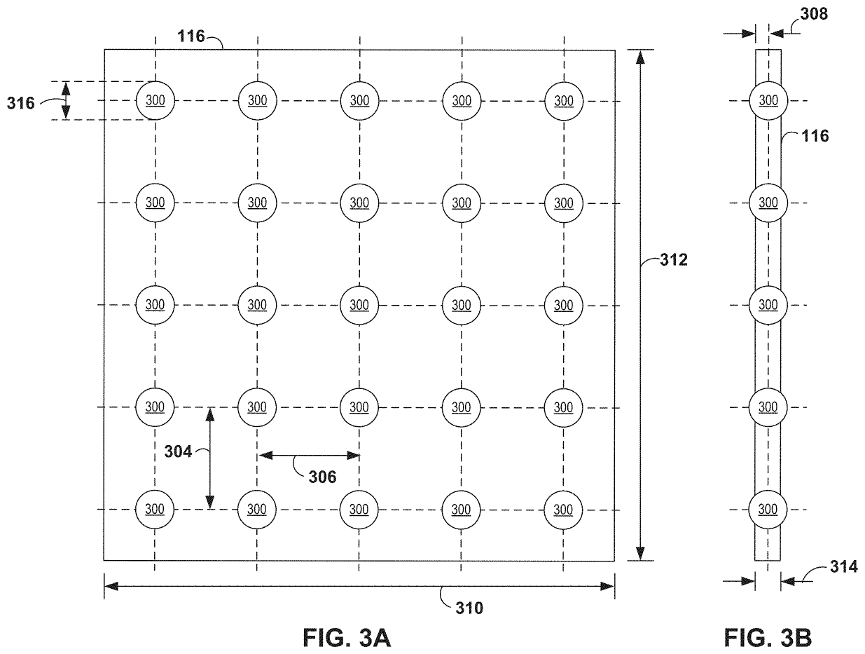

FIGS. 3A-3B are illustrations depicting an example of calibration object 116 of FIG. 1 from various perspectives. Specifically, FIG. 3A depicts an example front view of calibration object 116 and FIG. 3B depicts an example side view of calibration object 116. As depicted in FIGS. 3A and 3B, calibration object 116 is manufactured from an x-ray-transparent material, such as a graphite or carbon fiber. Calibration object 116 further includes a plurality of reference points 300. Each of the plurality of reference points 300 are manufactured from an x-ray attenuating material, such as tungsten-carbide or steel. While in the example of FIGS. 3A-3B, calibration object 116 is manufactured from an x-ray-transparent material and the plurality of reference points 300 are manufactured from an x-ray opaque material, in other examples, calibration object 116 is manufactured from an x-ray-opaque material and the plurality of reference points 300 are manufactured from an x-ray transparent material.

In the example of FIGS. 3A-3B, the plurality of reference points 300 comprise a plurality of spheres, such as steel ball-bearings. Each of the plurality of reference points 300 is arranged in a grid pattern. In the example of FIGS. 3A-3B, the plurality of reference points 300 are arranged in a 2D 5×5 grid pattern (e.g., 5 rows and 5 columns). Furthermore, the plurality of reference points 300 comprises respective spatial characteristics that are precisely measured or calibrated. For example, the spatial characteristics may include a width 310 of calibration object 116, a height 312 of calibration object 116, a depth 314 of calibration object 116, a diameter 316 of each of reference points 300, a vertical spacing 304 of each reference point 300 with respect to another reference point 300, a horizontal spacing 306 of each reference point 300 with respect to another reference point 300, or a depth 308 of each reference point 300 within calibration object 116.

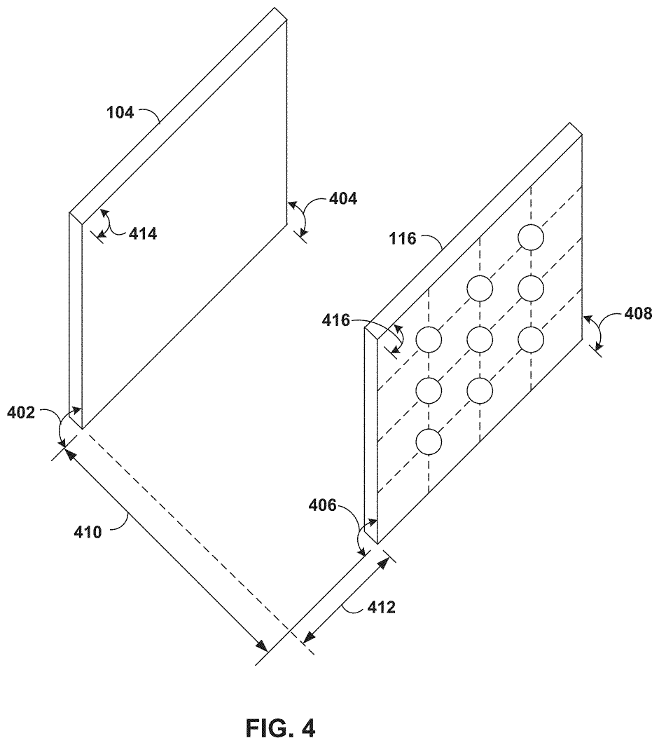

FIG. 4 is a block diagram illustrating the example x-ray inspection apparatus of FIG. 1 in further detail. As depicted in FIG. 4, x-ray detector 104 obtains each 2D image of a plurality of 2D images from different positions of a plurality of calibration positions. Each of the calibration positions corresponds to a different spatial arrangement of the x-ray detector relative to the calibration object. As described above with respect to FIG. 1, x-ray detector 104 may be affixed to drive apparatus 136, which may be configured to move x-ray detector 104 to various positions. For example, drive apparatus 136 may move x-ray detector 104 to each of a plurality of calibration positions, each calibration position being a measured or calibrated distance from x-ray detector 104 to calibration object 116 and/or one or more reference points of calibration object 116. For example, drive apparatus 136 may position x-ray detector 104 at a plurality of calibration positions, each calibration position having one or more of a measured depth offset 410 from calibration object 116, a measured width offset 412 from calibration object 116, a measured pitch angle 404 of x-ray detector 104 with respect to a measured pitch angle 408 of calibration object 116, a measured roll angle 402 of x-ray detector 104 with respect to a measured roll angle 406 of calibration object 116, or a measured yaw angle 414 of x-ray detector 104 with respect to a measured yaw angle 416 of calibration object 116. While not depicted in FIG. 4, each calibration position of the plurality of calibration positions may be measured with respect to a distance between x-ray detector 104 and one or more one or more reference points of calibration object 116 in addition to, or in the alternative to, being measured with respect to calibration object 116. In some examples, a drive apparatus (e.g., drive assembly 122) may be configured to move calibration object 116 instead of x-ray detector 104 or in addition to x-ray detector 104 so that x-ray detector 104 and calibration object 116 may have each of the calibration positions.

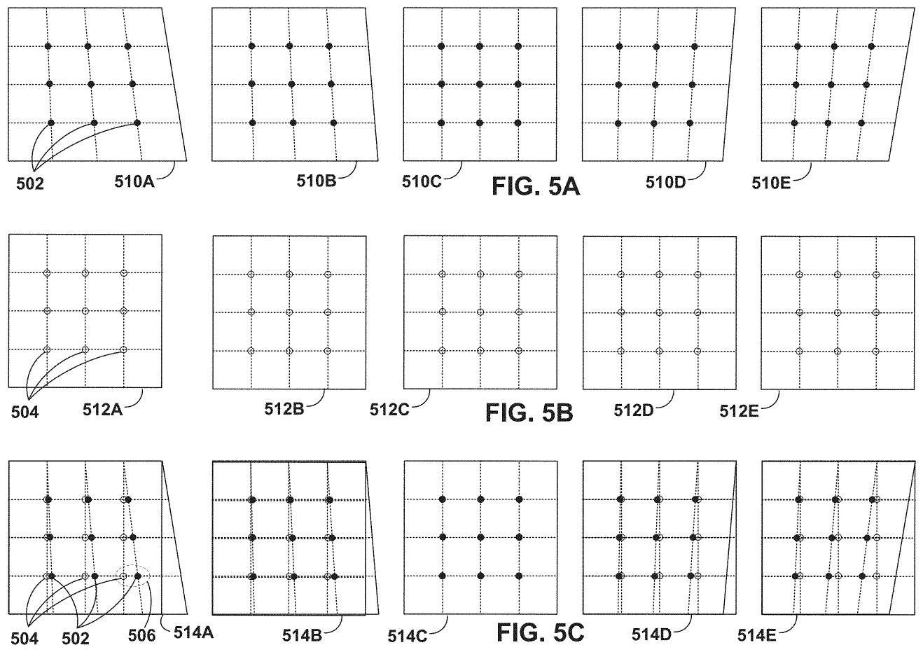

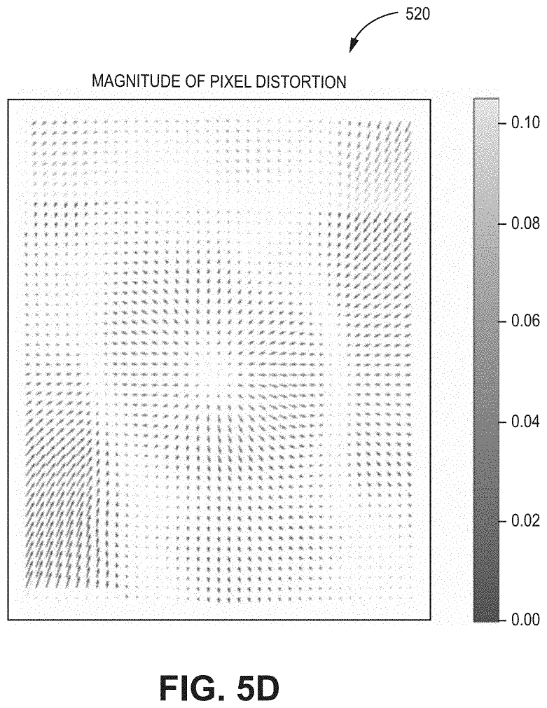

FIG. 5A is an illustration of imaged positions 502 of a plurality of reference points 300 as depicted in a plurality of 2D images 510A-510E (collectively, “plurality of 2D images 510”) obtained by x-ray detector 104 at a plurality of calibration positions in accordance with the techniques of this disclosure. In some examples, each of the plurality of 2D images 510 is obtained by x-ray detector 104 of FIG. 1 at the plurality of different positions of x-ray detector 104 depicted in, e.g., FIG. 2.

Due to variations in manufacturing of the plurality of pixels of x-ray detector 104, the plurality of pixels of x-ray detector 104 may exhibit inconsistencies or variations across x-ray detector 104 that result in distortion of each 2D image 510. For example, these image distortions may cause the imaged characteristics of the plurality of reference points 300 in each of the plurality of 2D images 510 to vary from the spatial characteristics of the plurality of reference points. As illustrated in the example of FIG. 5A, the image distortion causes imaged positions 502 of the plurality of reference points 300 of calibration object 116 to vary slightly from the spatial positions of the plurality of reference points 300 in the real world.

It should be noted that the pixel distortion depicted in FIG. 5A is provided as an illustration for ease of explanation only. FIG. 5A greatly exaggerates the pixel distortion that may occur in x-ray detector 104. In the real world, such pixel-specific distortion may be subpixel distortion on the order of, e.g., 0.02 to 0.1 pixels. The effect of the pixel-specific distortion may be pronounced on 3D volumes comprised of a plurality of 2D images. For example, such pixel-specific distortion may cause length errors of portions of an object depicted as a 3D volume. As described in more detail below, the techniques of the disclosure may reduce such distortion present in a plurality of 2D images of an object, as well as reduce such distortion within a reconstructed 3D volume of the object.

For example, as depicted in FIG. 5A, the imaged characteristics of the plurality of reference points 300 in each of the plurality of 2D images 510 is an imaged position 502 of each of the plurality of reference points 300 in each of the plurality of 2D images 510. In other examples, the imaged characteristics may be, e.g., an imaged size, an imaged spacing, or an imaged position of the plurality of reference points 300 in the plurality of 2D images 510. As depicted in the example of FIG. 5A, the plurality of reference points 502 comprise a plurality of x-ray attenuating spheres arranged in a grid pattern. In this example, the imaged characteristics of the plurality of reference points 502 are, e.g., an imaged position 502 of each x-ray attenuating sphere in relation to each other x-ray attenuating sphere of the plurality of x-ray attenuating spheres, as depicted in the 2D image obtained by x-ray detector 104 at a given position of x-ray detector 504.

Such image distortion may not be constant or uniform across the plurality of pixels of x-ray detector 104. For example, the image distortion may be dependent on a position of x-ray detector 104 with respect to calibration object 116, or nonlinear across the plurality of pixels of x-ray detector 104. In some examples, the image distortion across x-ray detector 104 may be described by a 3D image distortion field, such as a 3D rotational image distortion error between calibration object 116 and x-ray detector 104 or a 3D translational image distortion error between calibration object 116 and x-ray detector 104. As described in more detail below, image processing system 124 may compare the imaged position 502 of the plurality of reference points 300 in each 2D image 510 to the spatial characteristics of the plurality of reference points 300 (e.g., the position of each of the plurality of the reference points 300 in real space) to determine an image distortion field present across the plurality of pixels of x-ray detector 104.

FIG. 5B is an illustration of estimated positions 504 of a plurality of reference points 300 within a plurality of 2D images 512A-512E (collectively, “plurality of 2D images 512”) obtained by an ideal x-ray detector at each of the plurality of calibration positions in FIG. 5A in accordance with the techniques of this disclosure. In contrast to FIG. 5A, where each 2D image 510 represents an image obtained by x-ray detector 104 of reference points 300 of calibration object 116, each 2D image 512 of FIG. 5B represents an estimate 504 of the plurality of reference points 300 of calibration object 116 that an ideal x-ray detector would obtain at a specified position of x-ray detector 104. In contrast to 2D images 510, which exhibit image distortion in imaged characteristics of the plurality of reference points 502 due to manufacturing variances of x-ray detector 104, 2D images 512 do not exhibit image distortion because an ideal x-ray detector is a hypothetical construct that is not subject to error.

Therefore, because image processing system 124 does not have to consider manufacturing error in the ideal x-ray detector, image processing system 124 may use the spatial characteristics of the plurality of reference points of calibration object 116 and the calibrated positions of x-ray detector 104 to create estimates of how the plurality of reference points of calibration object 116 would appear in each 2D image 512 if x-ray detector 104 did not exhibit image distortion error. For example, as described above, the spatial characteristics of the plurality of reference points refers to the actual, calibrated, or measured position or size of the plurality of reference points in space (e.g., the real world). The spatial characteristics of the plurality of reference points may be, e.g., a size of each of the plurality of reference points or a position of each reference point of the plurality of reference points in relation to one another in space. For example, where the plurality of reference points comprise a plurality of x-ray attenuating spheres arranged in a grid pattern, the spatial characteristics may be, e.g., a size of each x-ray attenuating sphere or a position of each x-ray attenuating sphere in relation to each other x-ray attenuating sphere of the plurality of x-ray attenuating spheres. Typically, the size and/or position of each reference point is precisely determined such that calibration object 116 may be used to calibrate x-ray inspection apparatus as described herein. In the example of FIG. 5B, the spatial characteristics of reference points 300 is a position of reference points 300.

Further, at each position of the plurality of calibration positions, x-ray detector 104 is located at a measured orientation and/or position with respect to calibration object 116. Thus, by knowing one or more of a horizontal displacement, a vertical displacement, or a depth displacement of x-ray detector 104 with respect to calibration object 116, one or more of a roll angle, pitch angle, or a yaw angle of x-ray detector 104 with respect to calibration object 116, or one or more of a size, a spacing, or a position of the plurality of reference points of calibration object 116, image processing system 124 may calculate a projection of the plurality of reference points onto a 2D image for a specified position of x-ray detector 104 so as to generate each estimate 504 of the plurality of reference points 504 depicted in each of 2D images 512 of FIG. 5B.

FIG. 5C is an illustration of a difference between imaged positions 502 of the plurality of reference points 300 of FIG. 5A and estimated positions 504 of the plurality of reference points 300 of FIG. 5B in accordance with the techniques of this disclosure.

The example of FIG. 5C depicts, for ease of explanation of the techniques of the disclosure, the plurality of 2D images of FIG. 5A overlaid upon the plurality of 2D images of FIG. 5B to illustrate the differences between the imaged positions 502 of the plurality of reference points 300 of calibration object 116 in each of the plurality of 2D images 510 and the estimated positions 504 of the plurality of reference points 300 of calibration object 116 in each of the plurality of 2D images 512.

Image processing system 124 uses the imaged positions 502 of the plurality of reference points 300 of calibration object 116 in each of the plurality of 2D images 510 and the estimated positions 504 of the plurality of reference points 300 of calibration object 116 in each of the plurality of 2D images 512 to compute an image distortion field across the plurality of pixels of x-ray detector 104. An example of such an image distortion field is depicted below with respect to FIG. 5D. For example, each 2D image of the plurality of 2D images corresponds to a calibration position of the plurality of calibration positions. For each 2D image of the plurality of 2D images, image processing system 124 computes, an offset or difference 506 between each imaged position 502 of each of the plurality of reference points 300 and a corresponding estimated position 504 of each of the plurality of reference points 300. Image processing system 124 computes, based on each of the differences 506 between each of the imaged positions 502 and estimated positions 504, an image distortion field. The image distortion field describes a pixel-specific distortion error of each pixel of the plurality of pixels of x-ray detector 104.

FIG. 5D is an illustration of image distortion field 520 of x-ray detector 104 of FIG. 1 computed in accordance with the techniques of this disclosure. Image distortion field 520 may be, e.g., an example of the image distortion field computed above with respect to FIG. 5C. Image distortion field 520 describes the pixel-specific distortion error of each pixel of the plurality of pixels of x-ray detector 104. In some examples, image distortion field 520 is a vector field that describes a magnitude and direction of pixel-specific distortion across x-ray detector 104. As depicted in the example of FIG. 5D, such pixel-specific distortion may be subpixel distortion on the order of, e.g., 0.02 to 0.1 pixels.

Image processing system 124 computes, based on the computed image distortion field 520 across the plurality of pixels of x-ray detector 104, a correction transform for correcting image distortion across the plurality of pixels of x-ray detector 104. In some examples, the correction transform is a function that minimizes the vector field represented by image distortion field 520. For example, image processing system 124 computes the correction transform by approximating a function that, when applied to 2D images 510, minimizes the difference between each imaged position 502 of each of the plurality of reference points 300 of each of 2D images 510 and a corresponding estimated position 504 of each of the plurality of reference points 300 of each of 2D images 512 for each of the plurality of calibration positions. In some examples, the resulting approximated function is the correction transform. In some examples, to approximate the function that minimizes the difference, image processing system 124 applies a least squares function approximation to minimizes the difference.

Subsequently, x-ray detector 104 may obtain a preliminary 2D image of an object under test (e.g., calibration object 116 or another object, such as an object undergoing production testing). Image processing system 124 applies the computed correction transform to the preliminary 2D image to generate a corrected 2D image of the object under test. The corrected 2D image may exhibit reduced pixel-specific image distortion as compared to the preliminary image.

Therefore, by comparing the estimated positions 504 of the plurality of reference points 300 to the imaged positions 502 of the plurality of reference points, image processing system 124 may calculate image distortion field 520 for x-ray detector 104 and generate a correction field to reduce image distortion present in images obtained by x-ray detector 104. Furthermore, the use of such techniques may obviate the need to generate and/or maintain a 3D model of calibration object 116 and apply computationally complex corrections to the 3D model to remove such image distortion error. Thus, the techniques of the disclosure may allow an x-ray inspection apparatus to generate and use a correction transform to reduce image distortion across a plurality of pixels of an x-ray detector so as to obtain high-fidelity images.

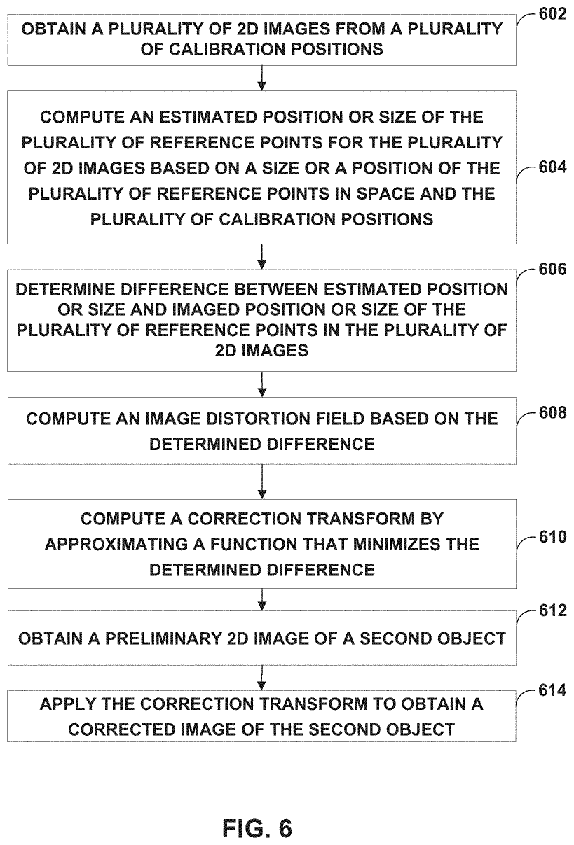

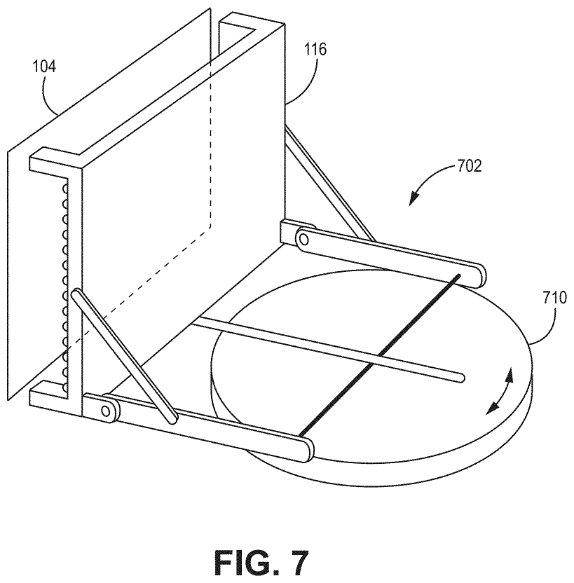

FIG. 6 is a flowchart illustrating an example operation in accordance with the techniques of the disclosure. Specifically, FIG. 6 depicts an operation for identifying and reducing pixel-specific image distortion of an x-ray detector of an x-ray inspection apparatus. For convenience, FIG. 6 is described with respect to the elements of FIG. 1.

X-ray detector 104 obtains a plurality of 2D images of calibration object 116 (602). X-ray detector 104 obtains each 2D image of the plurality of 2D images from a respective calibration position of a plurality of calibration positions. In some examples, drive apparatus 136 moves x-ray detector 104 to each of the plurality of calibration positions. Further, each calibration position of the plurality of calibration positions is a measured or calibrated distance of x-ray detector 104 with respect to calibration object 116. In other examples, a drive apparatus (e.g., drive assembly 122) moves one or more of calibration object 116 or a rotary table to which calibration object 116 is mounted to each of the plurality of calibration positions, wherein each calibration position of the plurality of calibration positions is a measured or calibrated distance of calibration object 116 with respect to x-ray detector 104.

Calibration object 116 includes one or more reference points 300. In some examples, the one or more reference points 300 comprise a plurality of x-ray opaque spheres arranged in a grid pattern. Each reference point 300 of the one or more reference points 300 comprise respective spatial characteristics. The respective spatial characteristics of the one or more reference points 300 comprise, for example, at least one of a size or a position of each reference point 300 in space. Further, each reference point 300 of the one or more reference points 300 depicted in each 2D image of the plurality of 2D images comprises respective imaged characteristics. The respective imaged characteristics of the one or more reference points 300 in each 2D image of the plurality of 2D images comprise at least one of an imaged size or an imaged position of the corresponding reference point 300.

Processing circuitry 132 computes an image distortion field across the plurality of pixels of x-ray detector 104 based on respective imaged characteristics of the one or more reference points 300 in each 2D image of the plurality of 2D images, respective spatial characteristics of the one or more reference points 300, and the plurality of calibration positions. For example, processing circuitry 132 computes an estimated position or an estimated size of each of the one or more reference points 300 in each 2D image of the plurality of 2D images at each position of the plurality of calibration positions based on the size or the position of each reference point 300 in space and the plurality of calibration positions (604).

Further, processing circuitry 132 determines a difference between the estimated position or the estimated size of each of the one or more reference points 300 in the plurality of 2D images at each of the plurality of calibration positions and the imaged position or the imaged size of each of the one or more reference points 300 in the plurality of 2D images at each of the plurality of calibration positions (606).

Processing circuitry 132 computes an image distortion field across the plurality of pixels of x-ray detector 104 based on the determined difference (608). For example, each 2D image of the plurality of 2D images corresponds to a position of the plurality of calibration positions. For each 2D image of the plurality of 2D images, image processing system 124 computes, an offset or difference 506 between each imaged position 502 of each of the one or more reference points 300 and a corresponding estimated position 504 of each of the one or more reference points 300. Image processing system 124 computes, based on each of the differences 506 between each of the imaged positions 502 and estimated positions 504, an image distortion field. The image distortion field describes a pixel-specific distortion error of each pixel of the plurality of pixels of x-ray detector 104.

Processing circuity 132 computes, based on the computed image distortion field across the plurality of pixels of the x-ray detector, a correction transform for correcting image distortion across the plurality of pixels of the x-ray detector. For example, processing circuity 132 computes the correction transform by approximating a function that minimizes the difference between the estimated position or the estimated size of each of the one or more reference points 300 in the plurality of 2D images at each of the plurality of calibration positions and the imaged position or the imaged size of each of the one or more reference points 300 in the plurality of 2D images at each of the plurality of calibration positions (610). In some examples, the resulting approximated function is the correction transform. In some examples, to approximate the function that minimizes the difference, processing circuity 132 applies a least squares function approximation to minimizes the difference.

As an illustrative example, processing circuitry 132 receives, as a first input, a 3D center point of each of the one or more reference points 300. Processing circuitry 132 receives, as a second input, an imaged 2D center point of each of the one or more reference points 300 in the plurality of 2D images at each of the plurality of calibration positions. Processing circuitry 132 estimates a 3D mapping from each of the estimated 3D center points to each of the imaged 2D center points. In some examples, the estimated 3D mapping is one or more of a 3D rotation, translation, and/or projection that is applied to each of the estimated 3D center points. To estimate the 3D mapping, processing circuitry 132 applies, based on the calibration positions, an estimated 3D transform (comprising one or more of a rotation and a translation) to each of the 3D center points of calibration object 116. Processing circuitry 132 further applies a system geometry to project the transformed 3D center points onto x-ray detector 104 to obtain estimated positions of the 3D center points at each of the plurality of calibration positions. The estimated system geometry comprises, e.g., a geometry between x-ray source 102 to calibration object 116 and a geometry between x-ray source 102 and x-ray detector 104.

With respect to the foregoing illustrative example, processing circuity 132 applies a least squares function approximation to determine a difference between the estimated positions of the 3D center points (e.g., the transformed and projected 3D center points) and the imaged 2D center points. The difference between the estimated 3D center points and the imaged 2D center points is considered error. Processing circuitry 132 applies a least squares function approximation to minimize such difference between the estimated 3D center points and the imaged 2D center points, wherein the resulting minimizing function determined by processing circuitry 132 is the correction transform.

Subsequent to computing the correction transform, x-ray detector obtains a preliminary 2D image of a second object (612). The second object may be, e.g., an object undergoing production testing. Processing circuitry 132 applies the correction transform to the preliminary 2D image to generate a corrected 2D image of the second object (614). The corrected 2D image may exhibit reduced pixel-specific image distortion as compared to the preliminary image. Therefore, the techniques of the disclosure enable processing circuitry 132 of x-ray inspection apparatus 100 to generate and use a correction transform to reduce image distortion across a plurality of pixels of x-ray detector 104 so as to obtain high-fidelity images.

FIG. 7 is an illustration depicting examples of x-ray detector 104, calibration object 116, and rotary table 710 of x-ray inspection apparatus 100 of FIG. 1. In some examples, rotary table 710 is an example of part carrier 110 of FIG. 1. As depicted in FIG. 7, fixture 702 affixes calibration object to rotary table 710 at a particular position with respect to x-ray detector 104. Fixture 710 allows x-ray detector 104 to obtain multiple x-ray images of calibration object 116 to where x-ray detector 106 is displaced laterally and/or vertically between acquisition of separate x-ray radiographs of calibration object 116. As described above, image processing system 124 may use the combined data of the multiple x-ray radiographs of calibration object 116 at various different positions of x-ray detector 104 to provide a more accurate determination of positionally-dependent distortion error than with the use of a single x-ray image alone.

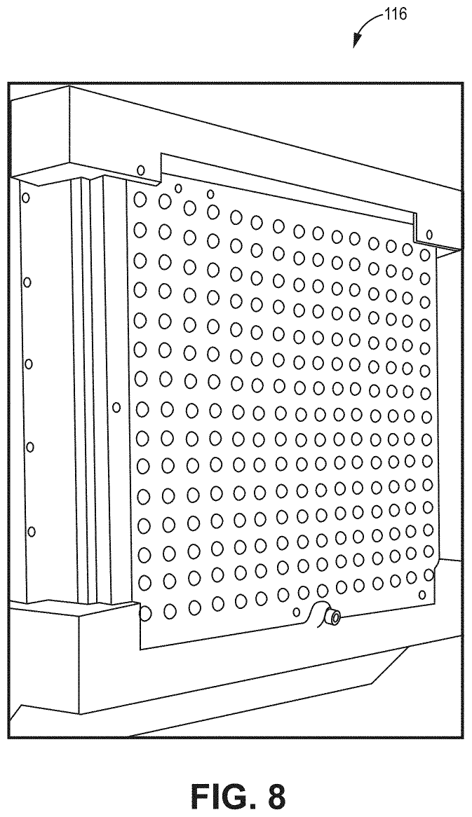

FIG. 8 is a photograph depicting another example of calibration object 116 of FIG. 1 in further detail. As depicted in FIG. 8, calibration object 116 is manufactured from an x-ray-transparent material. Calibration object 116 further includes a plurality of spheres. Each of the plurality of spheres are manufactured from an x-ray attenuating material. Each of the plurality of spheres is arranged in a grid pattern. In the example of FIG. 8, the spheres are arranged in a 15×15 grid pattern (e.g., 15 rows and 15 columns of spheres). Furthermore, the plurality of spheres comprises respective spatial characteristics that are precisely measured or calibrated. For example, the spatial characteristics may include a size of each of the spheres, a position of each of the spheres in space, or a spacing between each of the spheres. In some examples, each of the spheres is precisely positioned at a vertex of a grid pattern comprising squares of 1.0 square centimeter.

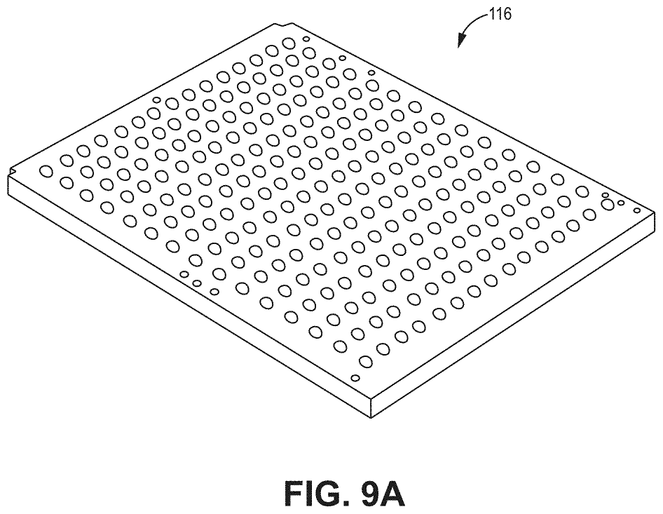

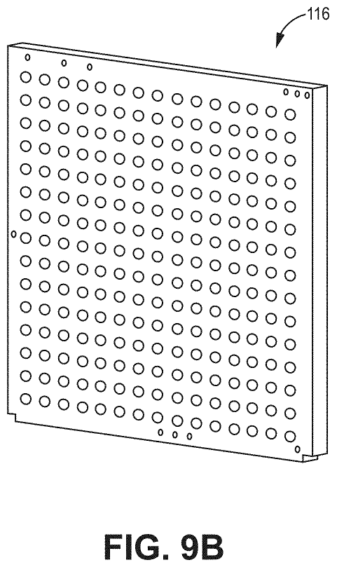

FIGS. 9A-9B are renderings of another example of calibration object 116 of FIG. 1 in further detail. As depicted in the example of FIGS. 9A-9B, calibration object 116 comprises an x-ray-transparent plate that is 244 millimeters by 95 millimeters by 10 millimeters in size. Calibration object 116 further comprises a plurality of x-ray-attenuating spheres (e.g., tungsten spheres) affixed to the plate and arranged in a 15×15 grid pattern. Each of the plurality of x-ray-attenuating spheres is about 6.75 millimeters in diameter. The example calibration object 116 of FIGS. 9A-9B is provided as an example only. The techniques of the disclosure may use a variety of calibration objects of various plate sizes, plate materials, sphere sizes, and/or sphere materials, such as the calibration objects depicted in any of FIGS. 3, 8, and 9A-9B, as well as other different types of calibration objects not expressly described herein.

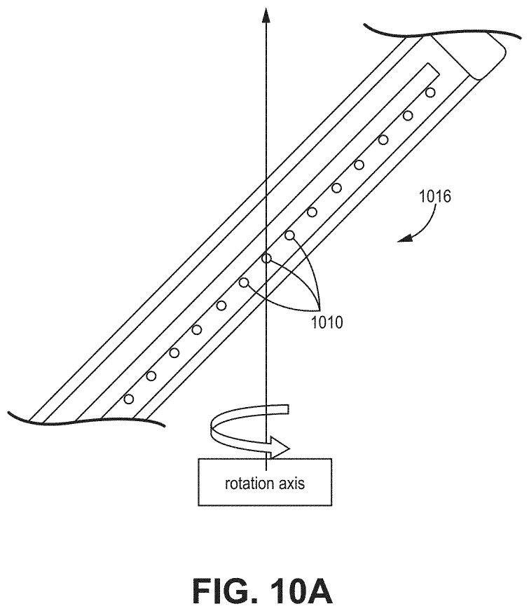

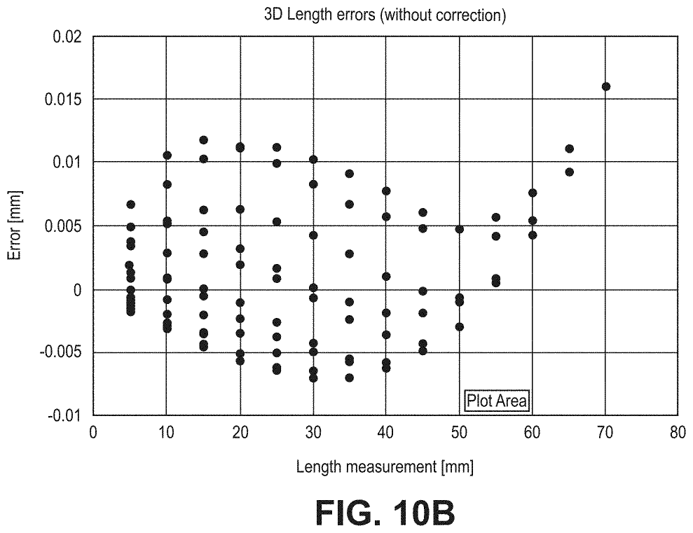

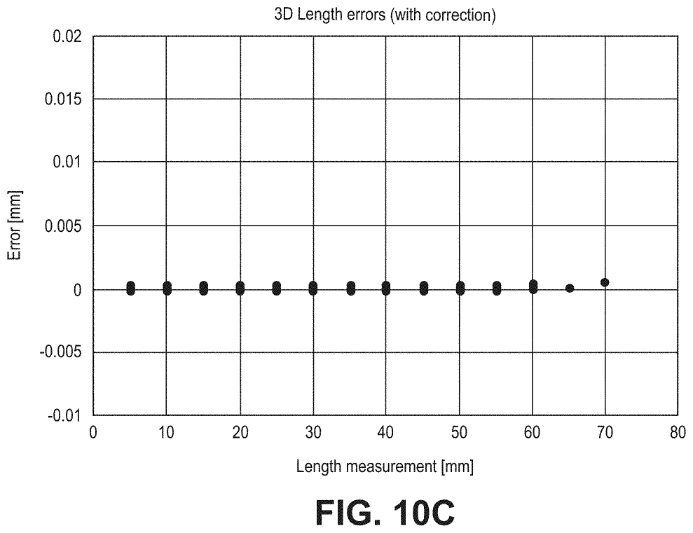

FIG. 10A is an example illustration of a radiograph of example calibration object 1016 of FIG. 1. In some examples, the radiograph is an example of one 2D image of the plurality of 2D images obtained by x-ray detector 104. In some examples, calibration object 1016 is an example of calibration object 116 depicted in FIGS. 3, 8, and 9A-9B. As depicted in the example of FIG. 10A, calibration object 1016 comprises a plurality of x-ray attenuating spheres 1010 whose center-to-center length is calibrated as described above. During a scan by x-ray detector 104 of FIG. 1, calibration object 1016 may be rotated, e.g., on a rotary table to obtain the plurality of 2D images. As depicted in the example of FIG. 10A, the projection of calibration object 1016 traverses the extent of the x-ray detector 104 as calibration object 1016 is rotated 360 degrees.

FIG. 10B is a chart illustrating pixel-specific image distortion present in the radiograph of FIG. 10A. FIG. 10C is a chart illustrating a reduction in the pixel-specific image distortion in the radiograph of FIG. 10A using the techniques of the disclosure. FIGS. 10B and 10C depict length error plots created in the following manner. More specifically, the chart of FIG. 10B illustrates an example of a length error plot illustrating magnitude and non-linear error patterns observed in pairwise center-to-center length measurements of spheres 1010. Further, the chart of FIG. 10C illustrates an example of a length error plot illustrating the effects of applying the correction transform described above to each radiograph of object 1016, of which FIG. 10A is an example.

Image processing system 124 computes 3D pairwise center-to-center length measurements between each of spheres 1010 in the CT volume of object 1016 (e.g., the imaged positions of each of spheres 1010 in the images obtained by x-ray detector 104). Image processing system 124 compares a difference between the 3D measured length and a 3D calibrated length for each possible length pair. The difference between the 3D measured length and the 3D calibrated length represents the image distortion error. Each of these errors is plotted in FIG. 10B. As depicted in the example of FIG. 10B, the errors exhibit a non-linear trend directly related to an image distortion field of x-ray detector 104. The errors range between plus and minus 1 micrometer.

FIG. 10C is similar to FIG. 10B, except that the computed correction transform described above is applied to the example radiograph of FIG. 10A to reduce image distortion error. As depicted in the example of FIG. 10C, after applying the correction transform, the magnitude of length error is substantially reduced in comparison to the length error of FIG. 10B where the correction transform is not applied.

The following examples may illustrate one or more aspects of the disclosure.

Example 1: A method that includes obtaining, with an x-ray detector comprising a plurality of pixels, a plurality of two-dimensional (2D) images of a calibration object, wherein each 2D image of the plurality of 2D images is obtained from a respective position of a plurality of calibration positions, wherein each of the plurality of calibration positions is a different spatial arrangement of the x-ray detector relative to the calibration object, and wherein the calibration object comprises one or more reference points; computing, with processing circuitry, an image distortion field across the plurality of pixels of the x-ray detector based on respective imaged characteristics of the one or more reference points in each 2D image of the plurality of 2D images, respective spatial characteristics of the one or more reference points, and the plurality of calibration positions; and computing, with the processing circuitry and based on the computed image distortion field across the plurality of pixels of the x-ray detector, a correction transform for correcting image distortion across the plurality of pixels of the x-ray detector, wherein the respective spatial characteristics of the one or more reference points comprise at least one of a size or a position of each reference point of the one or more reference points in space, and wherein the respective imaged characteristics of the one or more reference points in each 2D image of the plurality of 2D images comprise at least one of an imaged size or an imaged position of each reference point of the one or more reference points in each 2D image of the plurality of 2D images.

Example 2: The method of example 1, wherein computing the image distortion field across the plurality of pixels of the x-ray detector based on the respective imaged characteristics of the one or more reference points in each 2D image of the plurality of 2D images, the respective spatial characteristics of the one or more reference points, and the plurality of calibration positions comprises: computing at least one of an estimated position or an estimated size of each of the one or more reference points in each 2D image of the plurality of 2D images based on the at least one of the size or the position of each reference point of the one or more reference points in space and the plurality of calibration positions; determining a difference between the at least one of the estimated position or the estimated size of each of the one or more reference points in each 2D image of the plurality of 2D images and the at least one of the imaged size or the imaged position of each reference point of the one or more reference points in each 2D image of the plurality of 2D images; and computing the image distortion field across the plurality of pixels of the x-ray detector based on the determined difference.

Example 3: The method of example 2, wherein computing, based on the computed image distortion field across the plurality of pixels of the x-ray detector, the correction transform for correcting image distortion across the plurality of pixels of the x-ray detector comprises: approximating a function that minimizes the difference between the at least one of the estimated position or the estimated size of each of the one or more reference points in each 2D image of the plurality of 2D images and the at least one of the imaged size or the imaged position of each reference point of the one or more reference points in each 2D image of the plurality of 2D images, wherein the approximated function is the correction transform.

Example 4: The method of example 3, wherein approximating the function comprises applying a least squares function approximation.

Example 5: The method of any of examples 1 through 4, further that includes obtaining, by the x-ray detector, a preliminary 2D image of a second object; and applying, by the processing circuitry, the computed correction transform to the preliminary 2D image of the second object to generate a corrected 2D image of the second object, the corrected 2D image of the second object exhibiting less image distortion than the preliminary 2D image of the second object.

Example 6: The method of any of examples 1 through 5, wherein the image distortion field is nonlinear across the plurality of pixels of the x-ray detector.

Example 7: The method of any of examples 1 through 6, wherein the image distortion field across the plurality of pixels of the x-ray detector describes a three-dimensional (3D) image distortion error between the calibration object and the x-ray detector.

Example 8: The method of example 7, wherein the 3D image distortion error between the calibration object and the x-ray detector comprises a 3D rotational image distortion error between the calibration object and the x-ray detector.

Example 9: The method of any of examples 7 through 8, wherein the 3D image distortion error between the calibration object and the x-ray detector further comprises a 3D translational image distortion error between the calibration object and the x-ray detector.

Example 10: The method of any of examples 1 through 9, wherein each position of the plurality of calibration positions comprises a different vertical arrangement of the x-ray detector relative to the calibration object.

Example 11: The method of any of examples 1 through 10, wherein each position of the plurality of calibration positions comprises a different horizontal arrangement of the x-ray detector relative to the calibration object.

Example 12: The method of any of examples 1 through 11, wherein each position of the plurality of calibration positions comprises a different rotational arrangement of the x-ray detector relative to the calibration object.

Example 13: The method of any of examples 1 through 12, wherein the one or more reference points of the calibration object comprises a plurality of reference points.

Example 14: The method of example 13, wherein the plurality of reference points are arranged within a grid, each reference point of the plurality of reference points located at a vertex of the grid.

Example 15: The method of any of examples 1 through 14, wherein the one or more reference points of the calibration object comprises one or more x-ray attenuating spheres.

Example 16: The method of any of examples 1 through 15, wherein the x-ray detector comprises a flat-panel x-ray detector.

Example 17: The method of any of examples 1 through 15, wherein the x-ray detector comprises a linear diode array (LDA) x-ray detector.

Example 18: An x-ray inspection apparatus that includes an x-ray detector comprising a plurality of pixels, the x-ray detector configured to obtain a plurality of two-dimensional (2D) images of a calibration object, wherein the x-ray detector is configured to obtain each 2D image of the plurality of 2D images from a respective position of a plurality of calibration positions, wherein each of the plurality of calibration positions is a different spatial arrangement of the x-ray detector relative to the calibration object, and wherein the calibration object comprises one or more reference points; and processing circuitry configured to: compute an image distortion field across the plurality of pixels of the x-ray detector based on respective imaged characteristics of the one or more reference points in each 2D image of the plurality of 2D images, respective spatial characteristics of the one or more reference points, and the plurality of calibration positions; and compute, based on the computed image distortion field across the plurality of pixels of the x-ray detector, a correction transform for correcting image distortion across the plurality of pixels of the x-ray detector, wherein the respective spatial characteristics of the one or more reference points comprise at least one of a size or a position of each reference point of the pl one or more reference points in space, and wherein the respective imaged characteristics of the one or more reference points in each 2D image of the plurality of 2D images comprise at least one of an imaged size or an imaged position of each reference point of the one or more reference points in each 2D image of the plurality of 2D images.

Example 19: The x-ray inspection apparatus of example 18, wherein to compute the image distortion field across the plurality of pixels of the x-ray detector based on the respective imaged characteristics of the one or more reference points in each 2D image of the plurality of 2D images, the respective spatial characteristics of the one or more reference points, and the plurality of calibration position, the processing circuitry is configured to: compute at least one of an estimated position or an estimated size of each of the one or more reference points in each 2D image of the plurality of 2D images based on the at least one of the size or the position of each reference point of the one or more reference points in space and the plurality of calibration positions; determine a difference between the at least one of the estimated position or the estimated size of each of the one or more reference points in each 2D image of the plurality of 2D images and the at least one of the imaged size or the imaged position of each reference point of the one or more reference points in each 2D image of the plurality of 2D images; and compute the image distortion field across the plurality of pixels of the x-ray detector based on the determined difference.

Example 20: The x-ray inspection apparatus of example 19, wherein to compute, based on the computed image distortion field across the plurality of pixels of the x-ray detector, the correction transform for correcting image distortion across the plurality of pixels of the x-ray detector, the processing circuitry is configured to: approximate a function that minimizes the difference between the at least one of the estimated position or the estimated size of each of the one or more reference points in each 2D image of the plurality of 2D images and the at least one of the imaged size or the imaged position of each reference point of the one or more reference points in each 2D image of the plurality of 2D images, wherein the approximated function is the correction transform.

Example 21: The x-ray inspection apparatus of any of examples 18 through 20, wherein the x-ray detector is further configured to obtain a preliminary 2D image of a second object; and wherein the processing circuitry is further configured to apply the computed correction transform to the preliminary 2D image of the second object to generate a corrected 2D image of the second object, the corrected 2D image of the second object exhibiting less image distortion than the preliminary 2D image of the second object.

Example 22: The x-ray inspection apparatus of any of examples 18 through 21, wherein the image distortion field is nonlinear across the plurality of pixels of the x-ray detector.

Example 23: A non-transitory, computer-readable medium comprising instructions that, when executed, are configured to cause processing circuitry to: receive a plurality of two-dimensional (2D) images of a calibration object, each 2D image of the plurality of 2D images obtained from a respective position of a plurality of calibration positions, wherein each of the plurality of calibration positions is a different spatial arrangement of an x-ray detector comprising a plurality of pixels relative to the calibration object, wherein the calibration object comprises one or more reference points; compute an image distortion field across the plurality of pixels of the x-ray detector based on respective imaged characteristics of the one or more reference points in each 2D image of the plurality of 2D images, respective spatial characteristics of the one or more reference points, and the plurality of calibration positions; and compute, based on the computed image distortion field across the plurality of pixels of the x-ray detector, a correction transform for correcting image distortion across the plurality of pixels of the x-ray detector, wherein the respective spatial characteristics of the one or more reference points comprise at least one of a size or a position of each reference point of the one or more reference points in space, and wherein the respective imaged characteristics of the one or more reference points in each 2D image of the plurality of 2D images comprise at least one of an imaged size or an imaged position of each reference point of the one or more reference points in each 2D image of the plurality of 2D images.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

Various examples have been described. These and other examples are within the scope of the following claims.

What is claimed is:

1. A method comprising:
obtaining, with an x-ray detector comprising a plurality of pixels, a plurality of two-dimensional (2D) images of a calibration object, wherein each 2D image of the plurality of 2D images is obtained from a respective position of a plurality of calibration positions, wherein each of the plurality of calibration positions is a different spatial arrangement of the x-ray detector relative to the calibration object, and wherein the calibration object comprises one or more reference points;
computing, with processing circuitry, an image distortion field across the plurality of pixels of the x-ray detector based on respective imaged characteristics of the one or more reference points in each 2D image of the plurality of 2D images, respective spatial characteristics of the one or more reference points, and the plurality of calibration positions; and
computing, with the processing circuitry and based on the computed image distortion field across the plurality of pixels of the x-ray detector, a correction transform for correcting image distortion across the plurality of pixels of the x-ray detector,
wherein the respective spatial characteristics of the one or more reference points comprise at least one of a size or a position of each reference point of the one or more reference points in space, and
wherein the respective imaged characteristics of the one or more reference points in each 2D image of the plurality of 2D images comprise at least one of an imaged size or an imaged position of each reference point of the one or more reference points in each 2D image of the plurality of 2D images.

2. The method of claim 1,
wherein computing the image distortion field across the plurality of pixels of the x-ray detector based on the respective imaged characteristics of the one or more reference points in each 2D image of the plurality of 2D images, the respective spatial characteristics of the one or more reference points, and the plurality of calibration positions comprises:
computing at least one of an estimated position or an estimated size of each of the one or more reference points in each 2D image of the plurality of 2D images based on the at least one of the size or the position of each reference point of the one or more reference points in space and the plurality of calibration positions;
determining a difference between the at least one of the estimated position or the estimated size of each of the one or more reference points in each 2D image of the plurality of 2D images and the at least one of the imaged size or the imaged position of each reference point of the one or more reference points in each 2D image of the plurality of 2D images; and
computing the image distortion field across the plurality of pixels of the x-ray detector based on the determined difference.

3. The method of claim 2, wherein computing, based on the computed image distortion field across the plurality of pixels of the x-ray detector, the correction transform for correcting image distortion across the plurality of pixels of the x-ray detector comprises:
approximating a function that minimizes the difference between the at least one of the estimated position or the estimated size of each of the one or more reference points in each 2D image of the plurality of 2D images and the at least one of the imaged size or the imaged position of each reference point of the one or more reference points in each 2D image of the plurality of 2D images,
wherein the approximated function is the correction transform.

4. The method of claim 3, wherein approximating the function comprises applying a least squares function approximation.

5. The method of claim 1, further comprising:
obtaining, by the x-ray detector, a preliminary 2D image of a second object; and
applying, by the processing circuitry, the computed correction transform to the preliminary 2D image of the second object to generate a corrected 2D image of the second object, the corrected 2D image of the second object exhibiting less image distortion than the preliminary 2D image of the second object.

6. The method of claim 1, wherein the image distortion field is nonlinear across the plurality of pixels of the x-ray detector.

7. The method of claim 1, wherein the image distortion field across the plurality of pixels of the x-ray detector describes a three-dimensional (3D) image distortion error between the calibration object and the x-ray detector.

8. The method of claim 7, wherein the 3D image distortion error between the calibration object and the x-ray detector comprises at least one of a 3D rotational image distortion error between the calibration object and the x-ray detector or a 3D translational image distortion error between the calibration object and the x-ray detector.

9. The method of claim 1, wherein each position of the plurality of calibration positions comprises one or more of:
a different vertical arrangement of the x-ray detector relative to the calibration object;
a different horizontal arrangement of the x-ray detector relative to the calibration object; or
a different rotational arrangement of the x-ray detector relative to the calibration object.

10. The method of claim 1, wherein the one or more reference points of the calibration object comprises a plurality of reference points.

11. The method of claim 10, wherein the plurality of reference points are arranged within a grid, each reference point of the plurality of reference points located at a vertex of the grid.

12. The method of claim 1, wherein the one or more reference points of the calibration object comprises one or more x-ray attenuating spheres.

13. The method of claim 1, wherein the x-ray detector comprises a flat-panel x-ray detector.

14. The method of claim 1, wherein the x-ray detector comprises a linear diode array (LDA) x-ray detector.

15. An x-ray inspection apparatus comprising:
an x-ray detector comprising a plurality of pixels, the x-ray detector configured to obtain a plurality of two-dimensional (2D) images of a calibration object, wherein the x-ray detector is configured to obtain each 2D image of the plurality of 2D images from a respective position of a plurality of calibration positions, wherein each of the plurality of calibration positions is a different spatial arrangement of the x-ray detector relative to the calibration object, and wherein the calibration object comprises one or more reference points; and
processing circuitry configured to:
compute an image distortion field across the plurality of pixels of the x-ray detector based on respective imaged characteristics of the one or more reference points in each 2D image of the plurality of 2D images, respective spatial characteristics of the one or more reference points, and the plurality of calibration positions; and
compute, based on the computed image distortion field across the plurality of pixels of the x-ray detector, a correction transform for correcting image distortion across the plurality of pixels of the x-ray detector,
wherein the respective spatial characteristics of the one or more reference points comprise at least one of a size or a position of each reference point of the pl one or more reference points in space, and
wherein the respective imaged characteristics of the one or more reference points in each 2D image of the plurality of 2D images comprise at least one of an imaged size or an imaged position of each reference point of the one or more reference points in each 2D image of the plurality of 2D images.

16. The x-ray inspection apparatus of claim 15,
wherein to compute the image distortion field across the plurality of pixels of the x-ray detector based on the respective imaged characteristics of the one or more reference points in each 2D image of the plurality of 2D images, the respective spatial characteristics of the one or more reference points, and the plurality of calibration position, the processing circuitry is configured to:
compute at least one of an estimated position or an estimated size of each of the one or more reference points in each 2D image of the plurality of 2D images based on the at least one of the size or the position of each reference point of the one or more reference points in space and the plurality of calibration positions;
determine a difference between the at least one of the estimated position or the estimated size of each of the one or more reference points in each 2D image of the plurality of 2D images and the at least one of the imaged size or the imaged position of each reference point of the one or more reference points in each 2D image of the plurality of 2D images; and
compute the image distortion field across the plurality of pixels of the x-ray detector based on the determined difference.

17. The x-ray inspection apparatus of claim 16, wherein to compute, based on the computed image distortion field across the plurality of pixels of the x-ray detector, the correction transform for correcting image distortion across the plurality of pixels of the x-ray detector, the processing circuitry is configured to:
approximate a function that minimizes the difference between the at least one of the estimated position or the estimated size of each of the one or more reference points in each 2D image of the plurality of 2D images and the at least one of the imaged size or the imaged position of each reference point of the one or more reference points in each 2D image of the plurality of 2D images,
wherein the approximated function is the correction transform.

18. The x-ray inspection apparatus of claim 15,
wherein the x-ray detector is further configured to obtain a preliminary 2D image of a second object; and
wherein the processing circuitry is further configured to apply the computed correction transform to the preliminary 2D image of the second object to generate a corrected 2D image of the second object, the corrected 2D image of the second object exhibiting less image distortion than the preliminary 2D image of the second object.

19. The x-ray inspection apparatus of claim 15, wherein the image distortion field is nonlinear across the plurality of pixels of the x-ray detector.

20. A non-transitory, computer-readable medium comprising instructions that, when executed, are configured to cause processing circuitry to:
receive a plurality of two-dimensional (2D) images of a calibration object, each 2D image of the plurality of 2D images obtained from a respective position of a plurality of calibration positions, wherein each of the plurality of calibration positions is a different spatial arrangement of an x-ray detector comprising a plurality of pixels relative to the calibration object, wherein the calibration object comprises one or more reference points;
compute an image distortion field across the plurality of pixels of the x-ray detector based on respective imaged characteristics of the one or more reference points in each 2D image of the plurality of 2D images, respective spatial characteristics of the one or more reference points, and the plurality of calibration positions; and
compute, based on the computed image distortion field across the plurality of pixels of the x-ray detector, a correction transform for correcting image distortion across the plurality of pixels of the x-ray detector,
wherein the respective spatial characteristics of the one or more reference points comprise at least one of a size or a position of each reference point of the one or more reference points in space, and
wherein the respective imaged characteristics of the one or more reference points in each 2D image of the plurality of 2D images comprise at least one of an imaged size or an imaged position of each reference point of the one or more reference points in each 2D image of the plurality of 2D images.
